(19) United States
(12) Patent Application Publication
(10) Pub. No.: US 2010/0218426 A1
(43) Pub. Date: Sep. 2, 2010

(54) DOOR SAFETY DEVICE

(76) Inventor: Mark A. Johnson, Detroit, MI (US)

Correspondence Address: HARNESS, DICKEY & PIERCE, P.L.C., P.O. BOX 828, BLOOMFIELD HILLS, MI, 48303, US

(21) Appl. No.: 12/777,649

(22) Filed: May 11, 2010

Related U.S. Application Data
(63) Continuation-in-part of application No. 12/069,931, filed on Feb. 14, 2008, now Pat. No. 7,712,257.
(60) Provisional application No. 60/901,142, filed on Feb. 14, 2007.

(51) Int. Cl. E06B 7/00

(52) U.S. Cl. 49/383

(57) ABSTRACT

A safety system for a door-to-door jamb interface is provided. The safety interface uses several slidably joined members which are coupled to the door and its associated door jamb to prevent interaction between a user and the door-to-door jamb interface.

### CROSS-REFERENCE TO RELATED APPLICATIONS

This application is a continuation-in-part of U.S. patent application Ser. No. 12/069,931 filed on Feb. 14, 2008. This application further claims the benefit of U.S. Provisional Application No. 60/901,142, filed on Feb. 14, 2007. The disclosure of the above applications is incorporated herein by reference.

### FIELD

The present disclosure relates to a safety mechanism for a door structure, and more particularly to a safety enclosure mechanism for a door frame.

### BACKGROUND

The statements in this section merely provide background information related to the present disclosure and may not constitute prior art.

Inherent with standard door designs is the relative movement between hard and relatively sharp fixed surfaces. These surfaces often pose hazards to the fingers of children. As such, there is a need to reduce the risk to children caused by the moving surfaces of the door.

### SUMMARY

To overcome the deficiencies of standard door system, a safety system is provided. The safety system includes a louvered covering for the door jamb. One side of the louvered cover is coupled to the door, while the second side of the cover is coupled to the door frame.

In one embodiment, a louvered door jamb cover is provided. Each of the members of the louvers are coupled together using a pin and slot system. In this regard, the pins of a first louver member are configured to be slidably received within slots of a second louvered member. It is envisioned that the pins and slots can take a variety of different configurations.

In another embodiment, a pendulum is rotatably coupled to a front or rear face of the door. The pendulum is positioned so as the rotation of the pendulum positions a portion of the pendulum between the door and the door's jamb. A spring biases the pendulum into the location between the door and the door jamb. A user can retract the pendulum to allow the door to close.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 represents a standard door system;

FIG. 2 represents a door safety device according to one embodiment of the teachings;

FIG. 3 represents a top view of the system shown in FIG. 2;

FIGS. 4 and 5 represent cross-sectional views of the louvered system according to the teachings herein;

FIG. 6-10 represent an alternate embodiment of the teachings; and

FIGS. 11a and 11b represent an alternate embodiment of the present teachings.

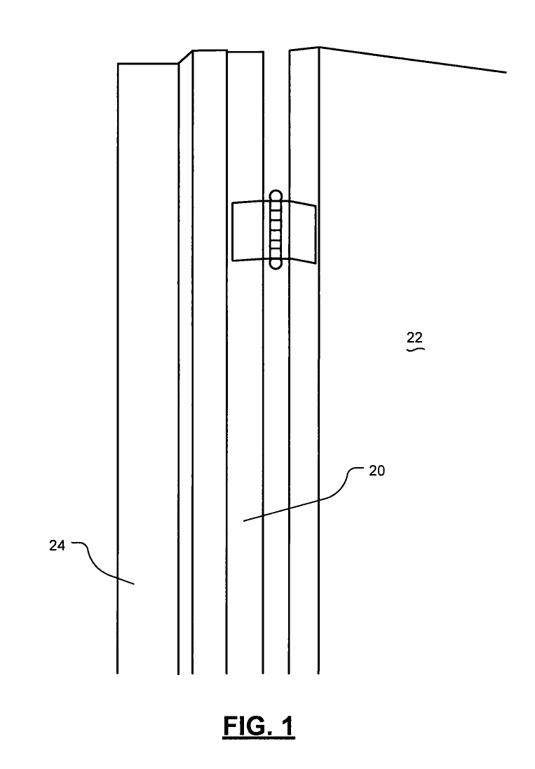

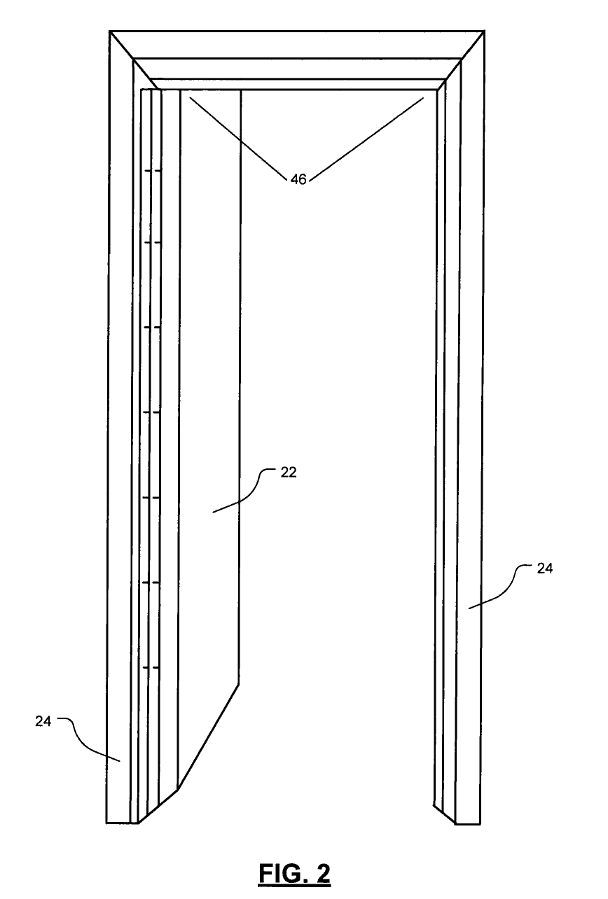

### DETAILED DESCRIPTION

The following description is merely exemplary in nature and is not intended to limit the present disclosure, application, or uses.

The safe door hinge system disclosed herein is configured to eliminate the danger to fingers or other anatomy created by a door and door jamb coming together at the hinged edge of the door when being closed. In the current design, used almost universally, a pinch point is created when the door and door jamb come together as the door is closed. Current door hinge design consists of two metal plates of equal size joined at one edge by a pivoting joint allowing the plates to open and close leaving no gap between them in the closed position.

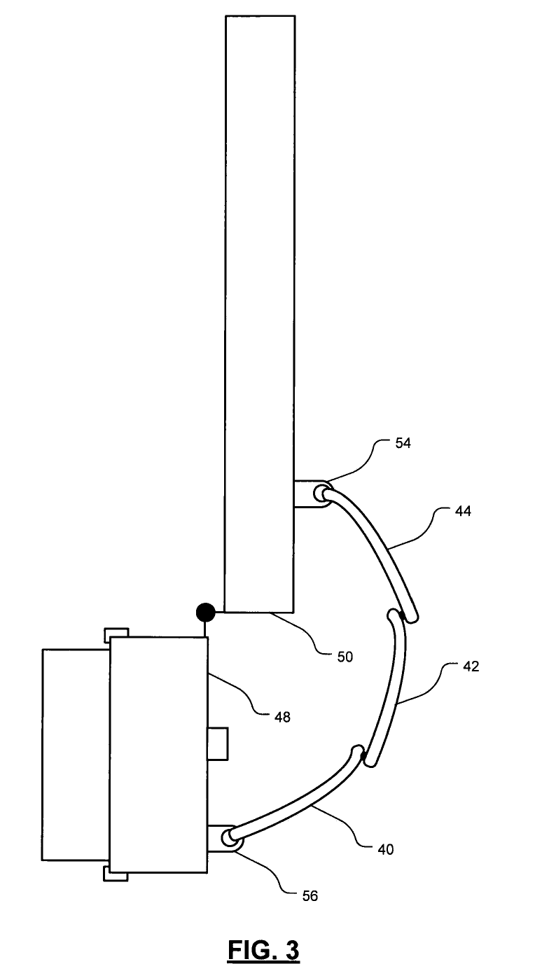

A finger guard device 26 is proposed to protect fingers or other anatomy from being injured by the forces produced by a door and door jamb 24 coming together at the hinged edge of a door 22 when being closed. The finger guard 26 covers the gap created between the door and the door jamb when a door is opened, thereby preventing fingers or other anatomy from being inserted and subsequently crushed or pinched when the door is closed. The finger guard 26 retrofits easily to existing doors and be easily removable, using Velcro as one possible means of attachment. The finger guard 26 can be formed of a plurality of polymer elongated curved or flat panels (40, 42, 44) (FIG. 3) running vertically the entire height of the door jamb up to the lintel 46 positioned in layers that would expand and contract horizontally to cover the gap between the door 22 and the jamb 24 as the door is opened or closed.

It is envisioned the panels (40, 42, 44) can be curved or flat and are configured to slide parallel to and behind one another when the door is closed, and expand as the door is opened.

The panels are connected to each other at any number of points along their height by horizontal fastening tracks consisting of a combination of pins and slots, rails and channels, hooks and rods, wheels and tracks, or any other fastening combination that would attach the panels together securely front to back, limit and control the gaps between the panels, and allow the panels to slide back and forth horizontally. The back of the top panel would be attached to the front of the second panel 42 and the back of the second panel would be attached to the front of the last panel 40. The first and last panels would be connected pivotally to the door and the door jamb respectively 54, 56 which would cause the entire device to expand and contract as the door is opened or closed.

A finger guard device 26 is proposed to protect fingers or other anatomy from being injured by the forces produced by a door and door jamb coming together at the hinged edge of a door when being closed. The finger guard 26 covers the gap created between the door and the door jamb when a door is opened thereby preventing fingers or other anatomy from being inserted and subsequently crushed or pinched when the door is closed. The finger guard would retrofit easily to existing doors and be easily removable using Velcro as one possible means of attachment. The finger guard would consist of any number of elongated panels 40, 42, 44 running vertically the entire height of the door jamb up to the lintel 46 positioned in layers that would expand and contract horizontally to cover the gap between the door 50 and the jamb 48 as the door is opened or closed. A portion of the elongated panels nest when the door is in an open position.

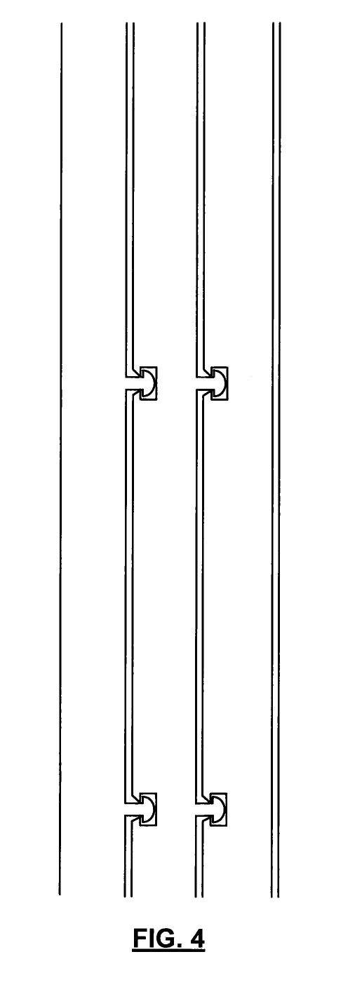

As shown in FIGS. 4 and 5, the panels can be coupled together using a pin and slot configuration. In this regard, it is envisioned that a first elongated panel 40 has a plurality of pins 30 which are slidably received within a slot defined within the second member 42. As shown in FIG. 5, the pins can be free floating within the slot 34 or can be coupled directly to an adjacent member. It is envisioned that the pins can have a plurality of head configurations of with either flat or curved interface surfaces. In this regard, the surfaces of the slots can be angled to interface with flat or curved surfaces of the pin or pin head.

It is envisioned that the system 26 can be coupled to the door or frame using fasteners such as screws nails or adhesives. The elongated members can be directly coupled to the frame and door, using a flange which is fixed to the elongated member. This flange can be pivotably or rigidly fixed to one elongated members.

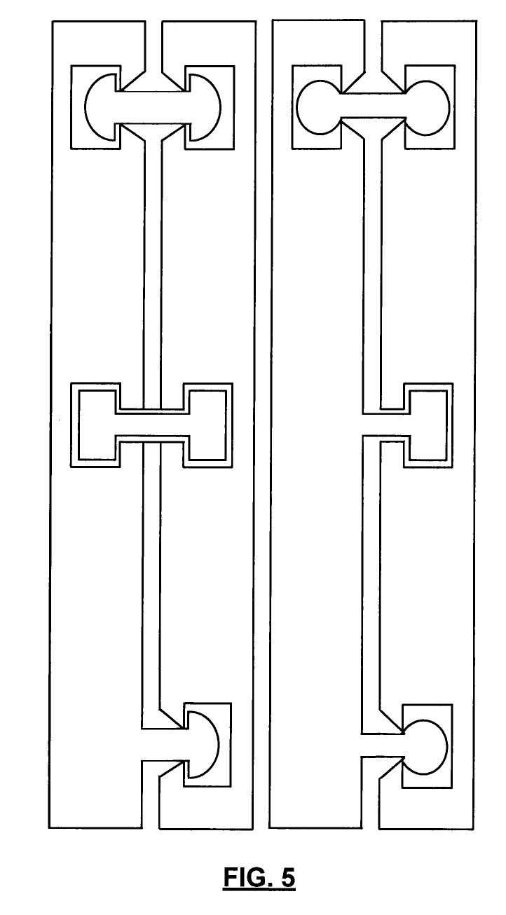

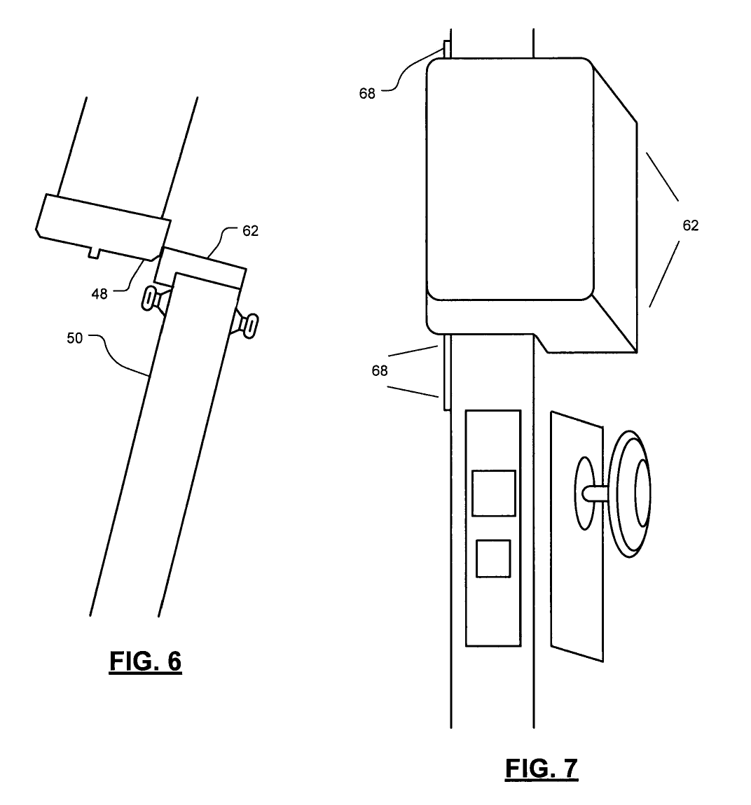

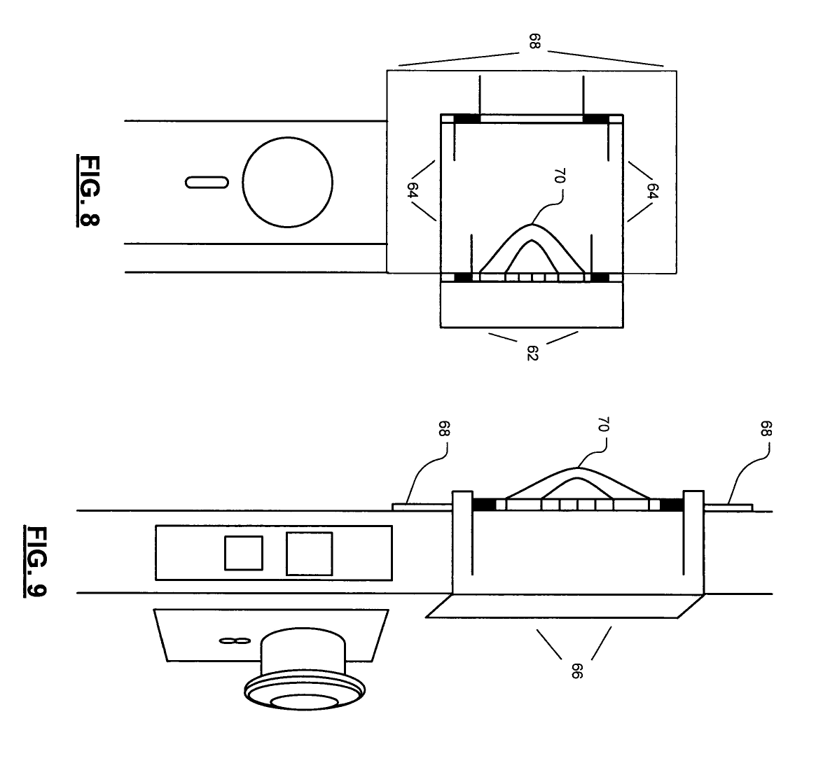

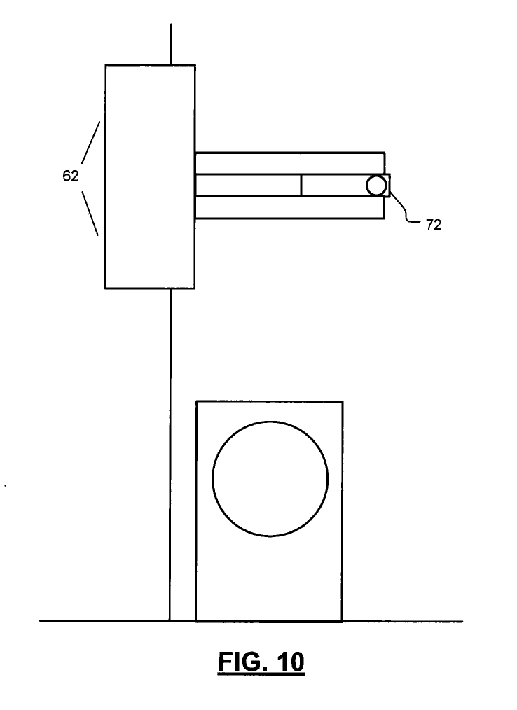

FIGS. 6-10 represent another embodiment which can be used with the system described above. The safe door stop 62 is configured to prevent injury to hands and fingers caused by contact with a door while being closed. As shown in FIG. 6, the safe door stop 62 is designed to prevent injuries occurring between the door 50 and the jamb 48 at the door knob edge of the door.

The safe door stop prevents injury by placing a soft barrier between the door and the door jamb automatically whenever the door is opened. Removing the barrier requires a user closing the door to pause and complete the final few inches of closing the door slowly with both hands. The necessity of using two hands requires that the closer face the door thereby increasing visibility and therefore safety. In addition the necessity of pausing and completing the final few inches slowly when closing a door gives anyone in close proximity to the door more time to see the door being closed, and move hands or fingers out of harms way. The safe door stop also prevents a door from being slammed or closed from behind.

The safe door stop 62 can consist of a soft stopper 63 coupled to a member to form a pendulum. As shown in FIGS. 8-10, a spring operated extension arm consisting of two hinged plates, a door face plate 64 and a door edge plate 68, and a holding bracket to secure the safe door stop to the door. It is envisioned the extension arm could also be of one piece design. The safe door stop operates automatically whenever a door is opened. As the door opens, door faces plate 64 is brought into full contact and held on the door face. As the door continues to open, door edge plate 66 with attached soft stopper 62 (FIG. 6) is brought into full contact and held on the edge of the door. To close the door, a handle 70 can be used to assist in holding the safe door stop away from the edge of the door when pushing the door closed, and a spring operated pusher 72 would be mounted on the opposite side of the door to push and hold the safe door stop away while pulling the door closed. Optionally, a locking mechanism can be used to position the locking pendulum into a disengaged position which would allow the normal opening and closing of the door.

The soft stopper could be a variable size and density sufficient enough to stop a door from closing while leaving a gap large enough to prevent any part of the door from contacting hands or fingers that may be in the path of the door. The holding bracket would be attached to the door with Velcro™ or could be attached in any other secure manner such as a nail, screw, bolt or adhesive.

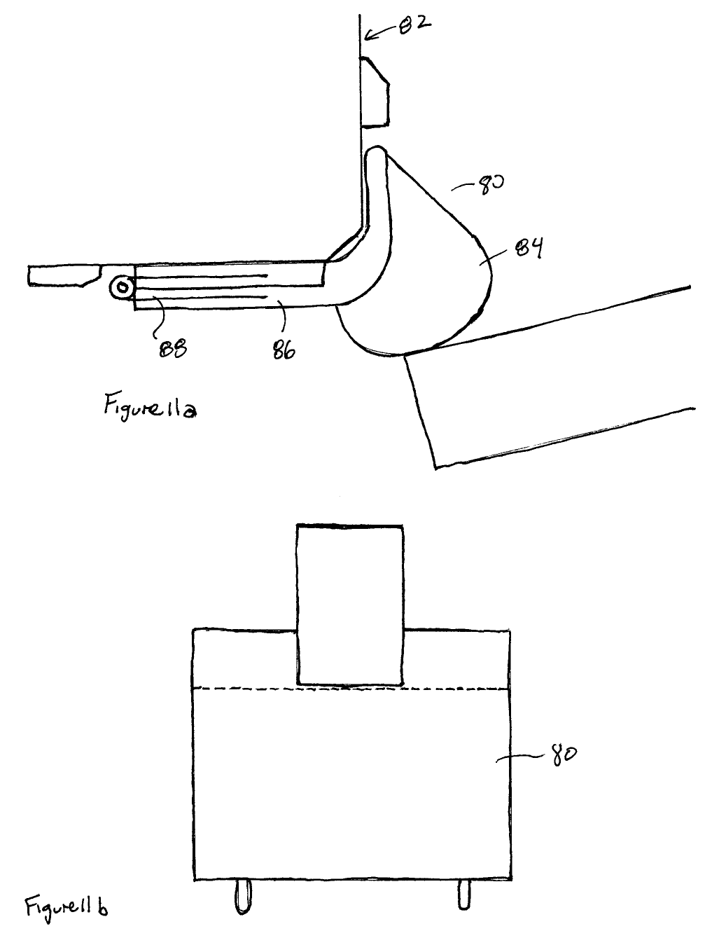

FIGS. 11a and 11b represent an alternate safety mechanism 80 according to the present teachings. Shown is a stop mechanism 80 which can be coupled to the front, rear, or interior of the door jam 82. The pendulum 86 has an interference stop 84, rotatably coupled to the jam 82. The pendulum 86 is rotatable from a first disengaged position to a second engaged position between the front edge and the jam. The door jam safety mechanism 80 can have a spring 88 configured to bias the stop 84 from the first disengaged position to the second engaged position. The stop 84 can be in the form of a soft polymer portion having a curved engagement surface which acts as an interface between the door and the jam. The door jam safety mechanism 80 can have a hinge 90 disposed between the pendulum and the jam. The hinge 90 pivotably couples the pendulum to the jam. The door jamb safety mechanism 80 further can have a lock to hold the pendulum in its first disengaged position. The pendulum can be formed of a spring member.

What is claimed is:

1. A door safety mechanism comprising:
a door panel, the door panel having a front edge, an upper end and a lower end;
a door jamb, said door jamb forming a frame around and adjacent to said door panel and adapted to abut said door panel when said door panel is in a closed position;
a pendulum rotatably coupled to one of a front or rear surface of the door, said pendulum being rotatable from a first disengaged position to a second engaged position between the front edge and the jamb.

2. The door jamb safety mechanism as recited in claim 1, further comprising a spring configured to bias the pendulum from the first disengaged position to the second engaged position.

3. The door jamb safety mechanism as recited in claim 1, wherein said pendulum comprises a first soft polymer portion.

4. The door jamb safety mechanism as recited in claim 1, comprising a hinge disposed between the pendulum and the door.

5. The door jamb safety mechanism as recited in claim 1, further comprising a lock to hold the pendulum in its first disengaged position.

6. A door safety mechanism comprising:
a door panel, the door panel having a front edge, an upper end and a lower end;
a door jamb, said door jamb forming a frame around and adjacent to said door panel and adapted to abut said door panel when said door panel is in a closed position;
a pendulum having an interference stop, rotatably coupled to one of a front, rear or interior surfaces of the jam, said pendulum being rotatable from a first disengaged position to a second engaged position between the front edge and the jamb.

7. The door jamb safety mechanism as recited in claim 6, further comprising a spring configured to bias the stop from the first disengaged position to the second engaged position.

8. The door jamb safety mechanism as recited in claim 7, wherein said pendulum comprises a first soft polymer portion.

9. The door jamb safety mechanism as recited in claim 8, comprising a hinge disposed between the pendulum and the door.

10. The door jamb safety mechanism as recited in claim 9, further comprising a lock to hold the pendulum in its first disengaged position.

11. The door jamb safety mechanism as recited in claim 10 wherein the pendulum is formed of a spring member.

12. The door jamb safety mechanism as recited in claim 12 wherein the first soft polymer portion has a curved engagement surface.
